(19) United States
(12) Patent Application Publication
(10) Pub. No.: US 2015/0073841 A1
(43) Pub. Date: Mar. 12, 2015

(54) METHOD AND SYSTEM FOR FACILITATING VACATION PLANNING AND MANAGEMENT

(71) Applicant: BLUE STAR INFOTECH LTD, Mumbai (IN)

(72) Inventors: Douglas A. Gray, Scottsdale, AZ (US); Radhakrishnan R., Mumbai (IN); Shrikant Patki, Mumbai (IN); Jignesh Shah, Mumbai (IN); Sumit Sheth, Mumbai (IN); Ramesh Naik, Bengaluru (IN)

(73) Assignee: BLUE STAR INFOTECH LTD, Mumbai (IN)

(21) Appl. No.: 14/281,768

(22) Filed: May 19, 2014

(30) Foreign Application Priority Data
May 19, 2013 (IN) IN3560/MUM/2012

(51) Int. Cl. G06Q 10/02; G06Q 50/14

(52) U.S. Cl. CPC G06Q 10/02; G06Q 50/14
USPC 705/5

(57) ABSTRACT

The invention provides a method and system for facilitating vacation planning and management. The method includes enabling planning of a vacation based on one or more of a user input, a user profile and a travel history associated with the user profile. The method also includes enabling booking of vacation and providing in-travel support. The in-travel support comprises providing one or more of a concierge service and a crisis management service during travel.

### FIELD OF THE INVENTION

The invention generally relates to the field of vacation planning More specifically, the invention relates to a method and system for facilitating vacation planning and management.

### BACKGROUND OF THE INVENTION

There are various avenues that can be used for planning vacations. Since the advent of the internet, a lot of online avenues such as online travel agencies have come up which assist users in planning vacations.

The current avenues for planning vacations generally require a user to have a plan in mind. For example, if one uses an air travel site for booking air tickets for a trip, the user would need to provide details regarding a source and a destination. Similarly, some of the present day avenues advertise a set of vacation packages, wherein the user can just select a desired vacation package from the set.

The existing systems either require users to plan a vacation from scratch on their own or the systems provide pre-planned vacation packages. Once the user plans the vacation and makes booking for the vacation, managing the vacation is dependent on various other factors such as, but not limited to, airport transfers, things to do in a vacation destination and utilizing time efficiently for each event of the vacation destination.

There is therefore a need for an improved method and system for assisting a user to plan and manage a vacation based on user preferences.

### BRIEF DESCRIPTION OF FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a system for facilitating vacation planning and management in accordance with an embodiment of the invention.

FIG. 2 illustrates a block diagram of the platform in accordance with the embodiment of the invention.

FIG. 3 illustrates a flow diagram of a method for facilitating vacation planning and management in accordance with an embodiment of the invention.

FIGS. 4-16 illustrate exemplary interfaces of a system for facilitating vacation planning and management to facilitate vacation planning and management.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the invention, it should be observed that the embodiments reside primarily in method steps and system components related to facilitating vacation planning and management.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Generally speaking, pursuant to various embodiments, the invention provides a method and system for facilitating vacation planning and management. The method includes enabling planning of a vacation based on one or more of a user input, a user profile and a travel history associated with the user profile. The method also includes enabling booking of the vacation and providing in-travel support. The in-travel support comprises providing one or more of, but not limited to, a concierge service and a crisis management service during travel.

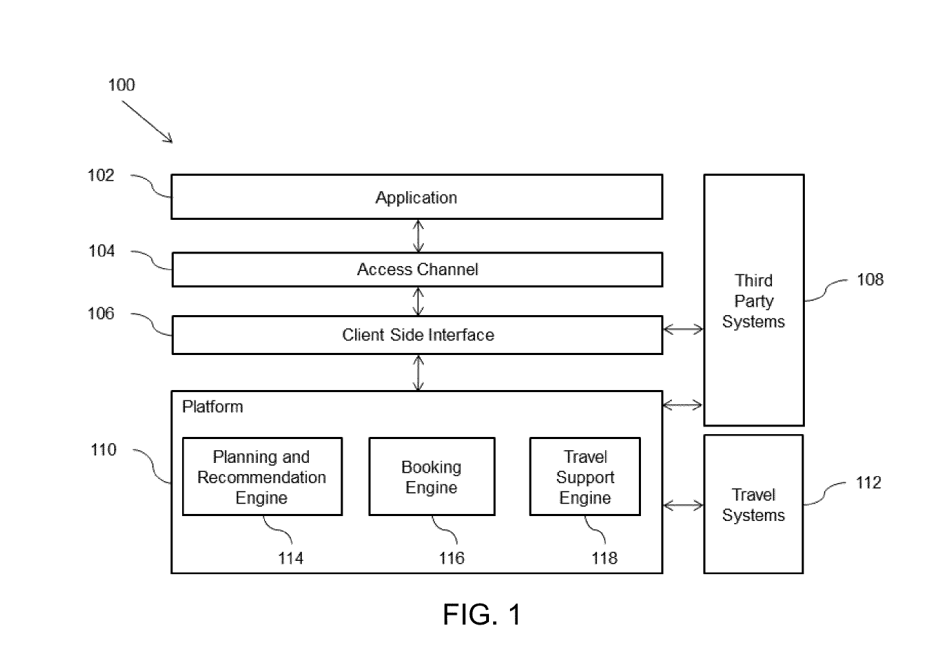

FIG. 1 illustrates a block diagram of a system 100 for facilitating vacation planning and management in accordance with an embodiment of the invention. System 100 includes an application 102, an access channel 104, a client side interface 106, third party systems 108, a platform 110 and travel system 112.

Application 102 is a client-side application, which is configured to facilitate a user in planning and managing a vacation. Application 102 accordingly can be one of, but not limited to, a mobile application, and a computer application. The user can install application 102 on access channel 104 to utilize the features provided by application 102, wherein access channel 104 can be a user device such as, but not limited to, a mobile phone, a smart phone, a laptop and a handheld device.

Application 102 is also configured to provide client-side interface 106 to the user for vacation planning and management. Client-side interface 106 can include one or more interfaces such as, but not limited to, a security interface, a message interface, a weather update interface, a notification interface, a theme interface, an offline viewing interface, a navigation interface and a chat interface. Each of the one or more interfaces is configured to facilitate interaction with one or more of a corresponding third party system of third party systems 108 and platform 110. Client-side interface 106 is configured to receive one or more inputs from the user. The user can provide the one or more inputs according to an application interface rendered to the user. For example, if a login page is rendered to the user via client-side interface 106, the user can provide a user name and a password for logging onto a user account of the user. The one or more inputs can include, but are not limited to, inputs for accessing a user account, inputs related to preferences for planning and managing of vacations, inputs related to vacation budgets, and inputs related to booking of vacations. It will be apparent to those ordinarily skilled in the art that the one or more inputs need not be limited to those mentioned above and can include any inputs that may be required for performing one or more functions of the method and system disclosed herein.

Third party systems 108 includes one or more of, but not limited to, social networking sites, weather service systems, map service systems, airport transfers, airline check-in systems, currency exchange systems, travel insurance systems, surveys and content providers.

Platform 110 includes one or more engines such as, but not limited to, a planning and recommendation engine 114, a booking engine 116 and a travel support engine 118.

Planning and recommendation engine 114 is configured to enable planning of a vacation based on the one or more of a user input, a user profile and a travel history associated with the user profile. Further, one or more of the user profile and the travel history associated with the user profile can be retrieved from a database (not illustrated) associated with planning and recommendation engine 114. The one or more inputs received from the user via client-side interface 106 are sent to planning and recommendation engine 114. In accordance with various embodiments of the invention, planning and recommendation engine 114 is configured to analyze and process the one or more inputs for planning the vacation. In addition, planning and recommendation engine 114 is configured to send results of the processing to the user via client-side interface 106. For example, planning and recommendation engine 114 can send probable vacation destinations based on the inputs received from the user. It will be apparent to those ordinarily skilled in the art that planning the vacation can involve multiple stages ranging from finding a vacation destination based on user preferences, selecting a vacation destination based on recommendations, planning travel itinerary and accommodation and booking. Accordingly, during these multiple stages, different inputs received from the user can be sent to planning and recommendation engine 114 based on which planning and recommendation engine 114 can send relevant results. The travel history associated with the user profile can be one or more vacation plans of the user. Planning and recommendation engine 114 can also configured to store the travel history associated with the user profile.

Planning and recommendation engine 114 is configured to process the one or more inputs for generating one or more recommendations. For example, if the user provides the inputs that are related to finding beach destinations located within proximity of 500 miles from the user's residence, then planning and recommendation engine 114 can process the inputs to recommend suitable beach destinations to the user. Planning and recommendation engine 114 is also configured to process the one or more inputs for suggesting one or more vacation itineraries. The one or more vacation itineraries can include, but are not limited to, travel itineraries, accommodation itineraries and itineraries related to one or more activities that the user may be interested in performing during the vacation For example, if the user selects a beach from a list of suggested beaches for a 3 day 4 night vacation, then planning and recommendation engine 114 can suggest one or more vacation itineraries for planning the 3 day 4 night vacation at the beach.

Additionally, platform 110 also includes a live chat support engine (not illustrate in FIG. 1). The live chat support engine is configured to enable a live chat session for facilitating vacation planning and management. The live chat session can be to a chat between the user and destination experts.

Booking engine 116 is configured to enable booking of the vacation. Booking engine 116 can be integrated with or connected to an online booking source such as a third party online travel agent system. For example, the third party online travel agent system can include details regarding different services provided by different service providers across various modes of travelling. Booking engine 116 is also configured to recommend an appropriate booking option based on one or more of the user input, the user profile and the travel history associated with the user profile. For example, a vacation package can be recommended for booking based on the user input, the user profile and travel history associated with the user profile.

Travel support engine 118 is configured to provide an in-travel support. The in-travel support provides one or more of a concierge service and a crisis management service during the travel. Travel support engine 118 is also configured to provide post-travel support. The post-travel support allows the user to submit feedback

The one or more engines of platform 110 are configured to interact with one or more of third party systems 108 and travel system 112 to facilitate vacation planning and management. Travel systems 112 can provide services such as, but not limited to, food and beverage services, property management services, point of sale services and spa as illustrated in FIG. 1.

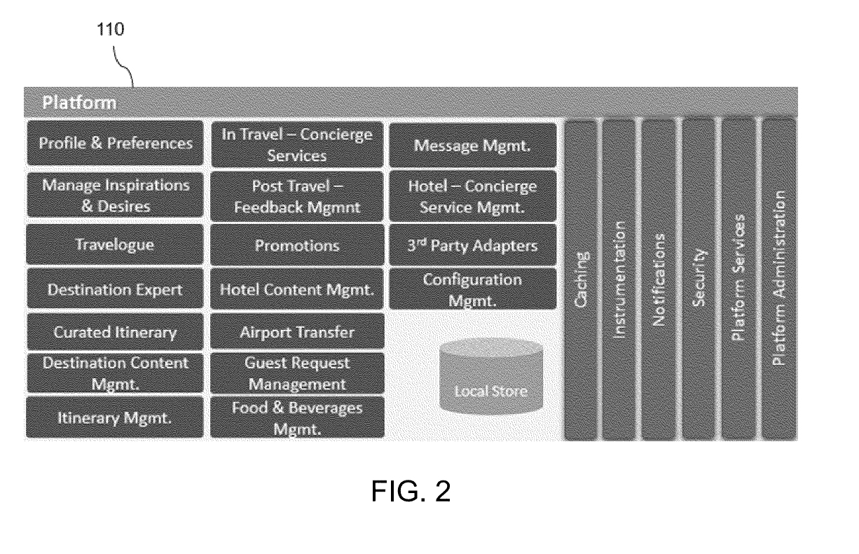

FIG. 2 illustrates a block diagram of platform 110 in accordance with an embodiment of the invention. In accordance with the embodiment, platform 110 includes a profile and preferences module, a inspirations and desires module, a travelogue module, a destination expert module, a curated itinerary module, a destination content management module, an itinerary management module, an in-travel-concierge services module, a post travel-feedback management module, a promotion module, a hotel content management module, an airport transfer module, a guest request management module, a food and beverages management, a message management module, a hotel-concierge services module, a third party adapter module, a configuration management module and a local store. Each of the modules of platform 110 illustrated in FIG. 2 can be a part of one or more of planning and recommendation engine 114, booking engine 116 and travel support engine 118. Alternatively, each of the modules of platform 110 can be an independent module in platform 110. Platform 110 is also configured to provide functionalities such as, but not limited to, caching, instrumentation, notifications, security, platform services and platform administration.

The profile and preference module is configured to enable a user to input information in the user profile, wherein the information can be related to the user and preferences of the user for a vacation. The profile and preference module is configured to enable the user to login to the user profile.

The inspirations and desires module is configured to manage inspirations and desires of the user which are provided as input by the user or identified based on travel history associated with the user profile. The inspirations and desires module is configured to enable a user to select an inspiration and one or more desires for a vacation. For example, the user can select romantic as an inspiration and music, dance, bird watching as desires for a vacation.

The travelogue module is configured to enable the user to create a travelogue. The travelogue can include details regarding a vacation, wherein the details can be entered before, during or after travel. The details can be content such as, but not limited to, images, videos and text. Examples of the travelogue can be, but need not be limited to, a trip book and a trip magazine. The travelogue module is also configured to enable the user to share the travelogue in a social network.

The destination expert module is configured to enable the user to interact with one or more destination experts based on the destination selected for a vacation. The user can interact with the one or more destination experts before or during travel. The destination expert module is configured to enable a user to interact with the one or more destination experts using one or more of, but not limited to, live chat, emails and call. The destination expert module is also configured to enable a user to add the one or more destination experts to a vacation diary.

The curated itinerary module is configured to enable the user to create a vacation dairy. The vacation diary provides an organized itinerary for the vacation. The destination content management module is configured to manage and store content associated with one or more destinations. The content associated with a destination can be one or more of name and description of the destination, places to visit, activities, hotels, relative pricing, weather and travel trends associated with the destination.

The itinerary management module is configured to manage the itinerary of the vacation. The itinerary management module is also configured to send alerts based on upcoming events in the itinerary. The in-travel concierge services module is configured to provide concierge services during the travel. The in-travel concierge services can include arranging transportation, arranging for reservations with restaurants or events and accessing entertainment guides. The post travel feedback management module is configured to enable the user to provide feedback regarding various services for during planning and managing the vacation. The promotion module is configured to deliver promotional offers before or during the vacation. The promotional offers can be offers for transportation, events in a vacation destination and reservations.

The hotel content management module is configured to manage and store content associated with one or more accommodations for the vacation. The airport transfer module is configured to provide transportation services to and from airports. The food and beverages management module is configured to provide services related to food and beverages during the travel. For example, if the user is vegetarian, the food and beverages management module is configured to provide name of restaurants which serve only vegetarian food. The guest request management module is configured to enable the user to place a request during the stay at the hotel. The guest request management module can be configured to enable the user to avail one or more services such as, but not limited to, room cleaning services, laundry and dry cleaning services, maintenance services and last minute packing services. Thus, the user can request the one or more of services provided by the hotel. The message management module is configured to send messages specific to a vacation plan of the user. The hotel concierge services module is configured to provide concierge services associated with a hotel which is booked for the vacation. The third party adapter module is configured to provide a communication mechanism to pass information back and forth between platform 110 and one or more of third party systems 108 and travel system 112 to facilitate vacation planning and management. The communication mechanism is provided for services such as, but not limited to, food and beverage services, property management services, point of sale services and spa. The configuration management module is configured to enable administrators to define and modify settings so that platform 110 can exchange relevant information with one or more third party system 108 and travel system 112 using the third party adapter module. The local store is configured to store information associated with the user profile, inputs from the user, travel history of the user, and one or more vacation plans of the user.

The caching functionality of platform 110 accelerates response to a user request to thereby provide superior performance to the user. The caching functionality locally stores and clears user specific data and general data based on a usage pattern heuristics. For example, if a plurality of users provides inputs that result in finding the same beach destinations, then the caching functionality stores the beach destinations locally. Thus, the need to request the destination from the third party system 108 is eliminated and the response is accelerated for the user request.

The notification functionality pushes notification messages from platform 110 to application 102. The notification messages are displayed on client side interface 106. The notification functionality can be used to deliver one or more messages specific to, but not limited to, crisis management, offers, marketing messages, weather alerts and reminders. For example, if a user is going to travel to Tokyo after 3 days, and an earthquake occurs in Tokyo, an alert can be pushed to the user using the notification functionality. Similarly, an alert can be generated based on the one or more events in the vacation diary.

The instrumentation functionality provides an overall supervisory control over different modules in platform 110. The instrumentation functionality provides combination of features including, but not limited to, measure and monitor performance, diagnostics, reports, and error logs related to the platform 110, third party systems 108, travel systems 112 and the third party adapter module.

The platform services functionality orchestrates actions across different modules such as, but not limited to, platform 110, third party systems 108, travel systems 112 and the platform services functionality ensures that the different modules act as a single system. The platform administration functionality provides access to the instrumentation functionality. The platform administration functionality also provides the ability to monitor the number of users using system 100, view error logs and enable or disable user accounts. The security functionality provides role based access controls. Using the security functionality, a platform administrator can create/delete user data, define roles and responsibilities, and assign roles and responsibility to users. The security functionality can enable authentication of a user based on login credentials and provide access to user specific data.

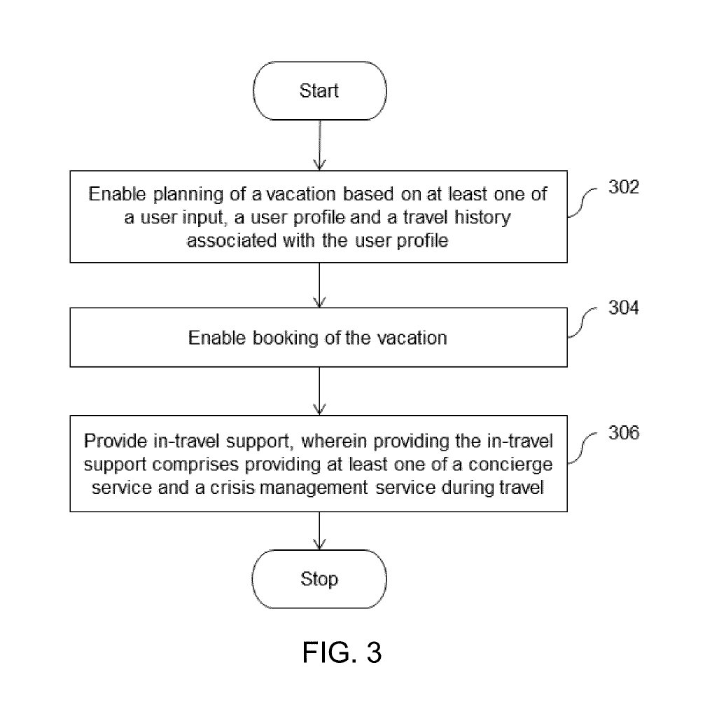

FIG. 3 illustrates a flow diagram of a method for facilitating vacation planning and management in accordance with an embodiment of the invention.

At step 302, vacation planning is enabled for a user based on one or more of a user input, a user profile and a travel history associated with the user profile. The one or more inputs can be one of, but not limited to, inputs for providing vacation preferences, inputs for viewing recommended destinations, inputs for selecting a destination, inputs for selecting activities to be performed at the destination, and inputs regarding selection of a hotel/resort to stay. It will be apparent to those skilled in the art that the one or more inputs can include any inputs that may be required for planning the vacation and need not be limited to the examples provided above. The inputs can be processed for generating recommendations for one or more vacation destinations, planning one or more vacations, one or more vacation itineraries, facilitating booking of the planned vacations and so forth. The recommendation can be generated while the user is planning the vacation based on the one or more of the user input, the user profile and the travel history associated with the user profile. The recommendation includes one or more of a destination, an activity, a mode of transport, an accommodation and an itinerary. For example, if the user desires to view beach destinations and provides corresponding input, then the input is processed to generate recommendations related to beaches.

In addition, the recommendations may be based on preferences of the user such as, but not limited to, distance from current location and duration of vacation. Similarly, if the user provides preferences related to certain activities to be performed at the destination, the one or more inputs are processed to generate recommendations regarding those activities. For example, if the user is interested in performing water related activities at a beach, then the user may be provided relevant recommendations such as, but not limited to, scuba diving and surfing. If the user provides preferences to view an itinerary, the one or more inputs are processed to generate itinerary recommendations. For example, after the user selects a destination, the user may provide preferences such as budget, vacation time, dates and activities. The preferences provided by the user are then processed to suggest the one or more vacation itineraries such as for example, vacation packages available at the destination that may be suitable to the user.

The step of planning can optionally include creating a vacation diary for scheduling one or more of a plurality of destination visits and a plurality of destination activities during the vacation. The vacation diary can include one or more events associated with the vacation. A schedule map can be generated based on the vacation diary. The schedule map includes a geographical map which displays locations associated with the events listed in the vacation diary. For example, the locations associated with the events can be pinned on the geographical map. The user can click on the pinned location and use navigation applications to reach the pinned location. The pins in the geographical map can be colored such that locations to be visited for different days are colored differently. For example, yellow color pins can be displayed for day 1 event locations, green color pins can be displayed for day 2 event locations and blue color pins can be displayed for day 3 event locations on the map. The schedule map also shows directions to the locations displayed in the geographical map from the current location of the user. Further, the directions from the location of each event planned for the vacation is also displayed in the scheduled map.

Further, an alert can be generated based on the one or more events in the vacation diary. The alert can remind the user of the events in the vacation diary. For example, an alert can be sent to the user at 2 PM if there is an event in the vacation diary at “location X” at 4 PM, as the user would require approximately 2 hours to travel from current location to “location X”.

The method further includes enabling booking of the vacation for the user at step 304. Thus, the booking associated with the vacation such as, but not limited to, accommodation, a mode of transport, activities and reservations in the vacation destination can be carried out by the user. For example, after the user selects one or more vacation itineraries recommended to the user, the user can be provided with the option to confirm the itineraries and proceed for booking based on the selection. An appropriate booking option is accordingly provided to the user based on one or more of the user input, the user profile and the travel history associated with the user profile.

At step 306, an in-travel support is provided, wherein the in-travel support provides one or more of a concierge service and a crisis management service during travel. The concierge services during the travel includes one or more of, but not limited to, arranging and booking transportation within in one or more vacation destinations, arranging airport transfers, arranging for reservations with restaurants or events in one or more vacation destinations, arranging for spa services, recommending night life hot spots, procurement of tickets to special events, arranging travel and tours to tourist attractions in one or more vacation destinations and access to entertainment guides. For example, if the user lands in a vacation destination, the airport transfers such as an option of booking of a car for rent to travel from the airport to a hotel is provided using the in-travel support.

The crisis management services includes alerting the user regarding crisis events in one or more vacation destinations, wherein the crisis events can be, but are not limited to, natural disasters, political instability, civil unrest, emergency situations, an industrial accident, a terrorist incident, sabotage, health epidemics, other criminal events including kidnapping or a severe weather events. For example, if a user is going to travel to Tokyo after 3 days, and an earthquake occurs in Tokyo, an alert can be sent to the user that Tokyo is hit by earthquake. The user can reschedule the vacation plan to Tokyo or change the vacation plan to a new destination.

The in-travel support also provides promotional content during travel. The promotional content can include promotions related to event in one or more of hotels, restaurants, markets and stores in the vacation destination.

Additionally, a post-travel support is also provided, wherein the post travel support enables the user to submit feedback before, during or after the travel.

A live chat support is also provided for facilitating vacation planning and management. The live chat support allows the user to interact with one or more destination experts based on a destination selected by the user for the vacation.

The method also enables the user to share the vacation information on a social network. For example, the user can share the curated itinerary for the vacation on the social network. Further, the user can create a travelogue for the vacation. The user can post contents associated with the vacation such as, but not limited to, images, text, videos, audio and geo-tags in the created travelogue. The user can also share the travelogue on the social network. The content associated with the vacation of the user can be access by social contacts of the user in real-time after the user shares the travelogue.

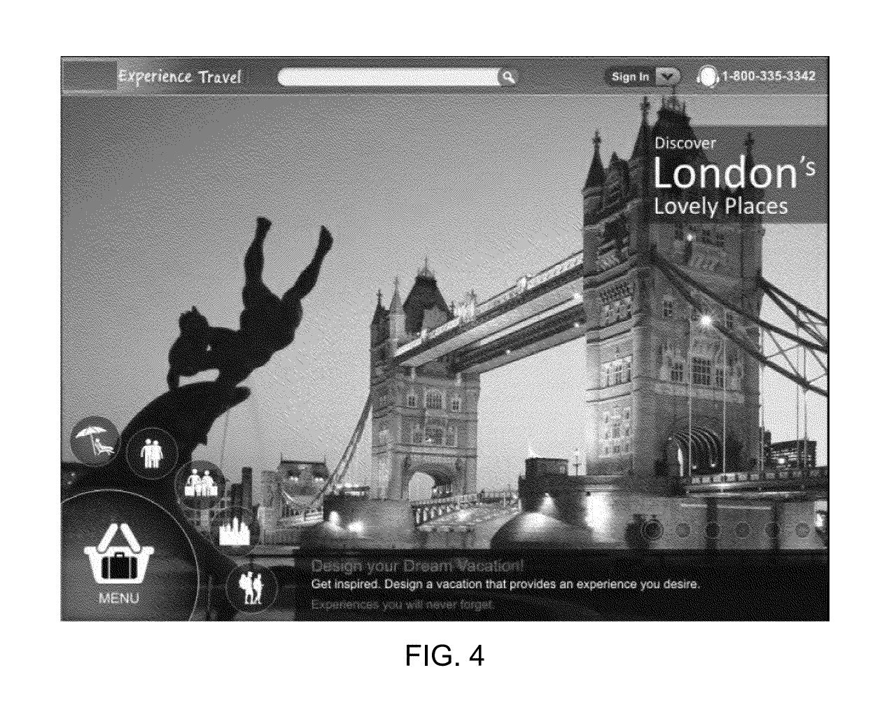

The following describes an exemplary scenario of planning and managing a vacation in accordance with the method and system disclosed herein, wherein FIGS. 4-16 illustrate exemplary user interfaces that are in accordance with various embodiments of the method and system disclosed herein.

As illustrated in FIG. 4, a home page for planning the vacation is displayed to a user. There are various options that are available to the user at the home page. For instance, the user can enter login details to login and access the user profile. Alternatively, the user can browse as a guest user without logging in. The home page can also display a menu button and a search bar. The user can accordingly perform keyword search using the search bar. Further, the space available on the home page can be utilized for presenting advertisements such as “discover London's lovely places” displayed in FIG. 4. Further, the user can select various inspiration buttons provided around the menu button such as, beach, romantic, family, pilgrimage and backpackers for planning the vacation.

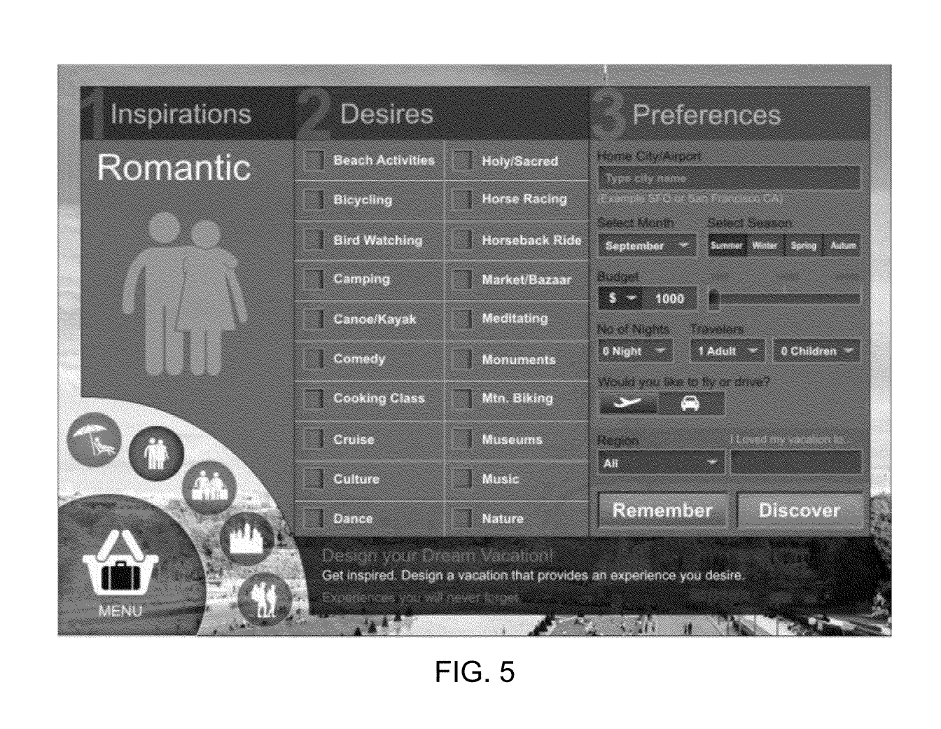

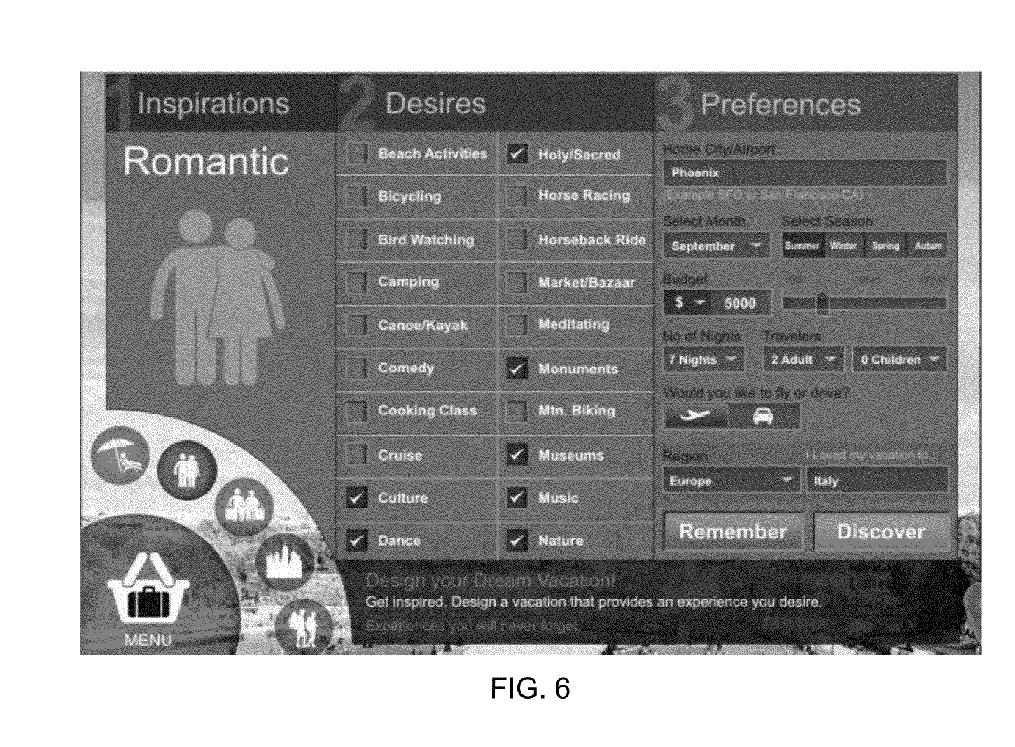

Assume that user selects ‘Romantic’ button as inspiration and a new screen as illustrated in FIG. 5 is displayed. In FIG. 5, options of desires and preferences are displayed to the user. The user can select one or more options provided in the desires and the preferences. For example, the user can select preferences such as, but not limited to, home city, airport, travel date, budget, number of days, number of people, mode of transport, and destination. The selection of desires and preferences of the user are illustrated in FIG. 6. The user can click on the remember button to save the desires and the preferences which can be used to plan the vacation at a later time. Alternatively, the user can select the discover button to search for various recommendations for the vacation plan.

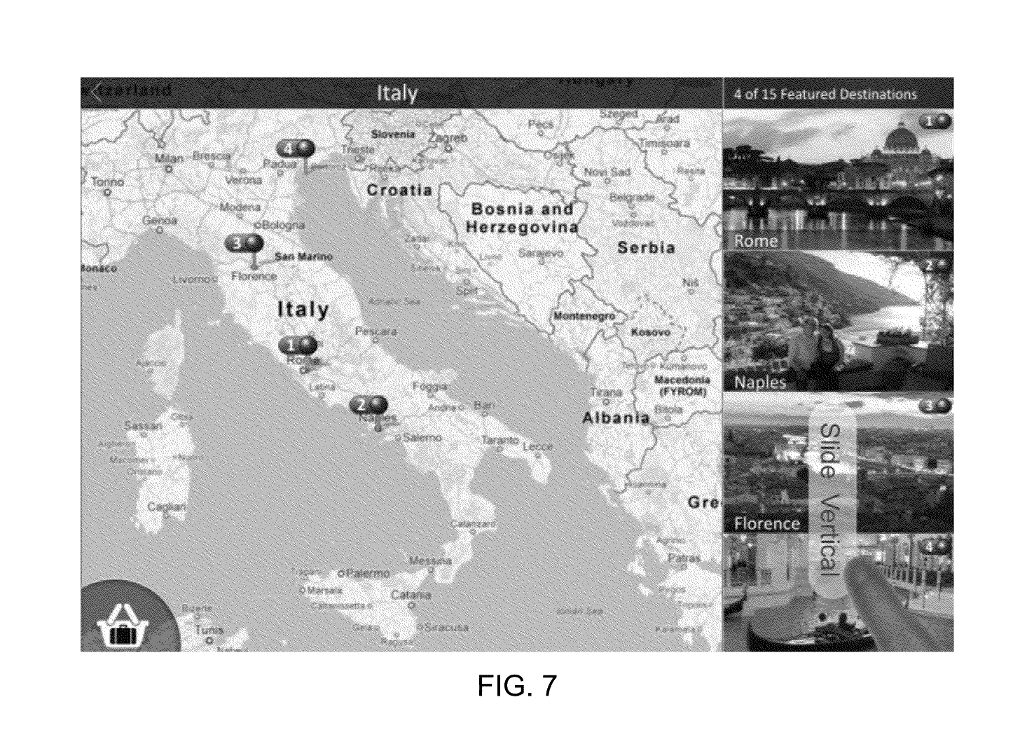

Assume that the user selects Italy as the vacation destination as illustrated in FIG. 6. Accordingly, as illustrated in FIG. 7, a map of Italy with recommended vacation destinations marked in the map is displayed to the user when the user clicks on discover button. Further, a list of the recommended vacation destinations is also displayed along with the map. The user can scroll through the list of recommended vacation destinations and select one destination.

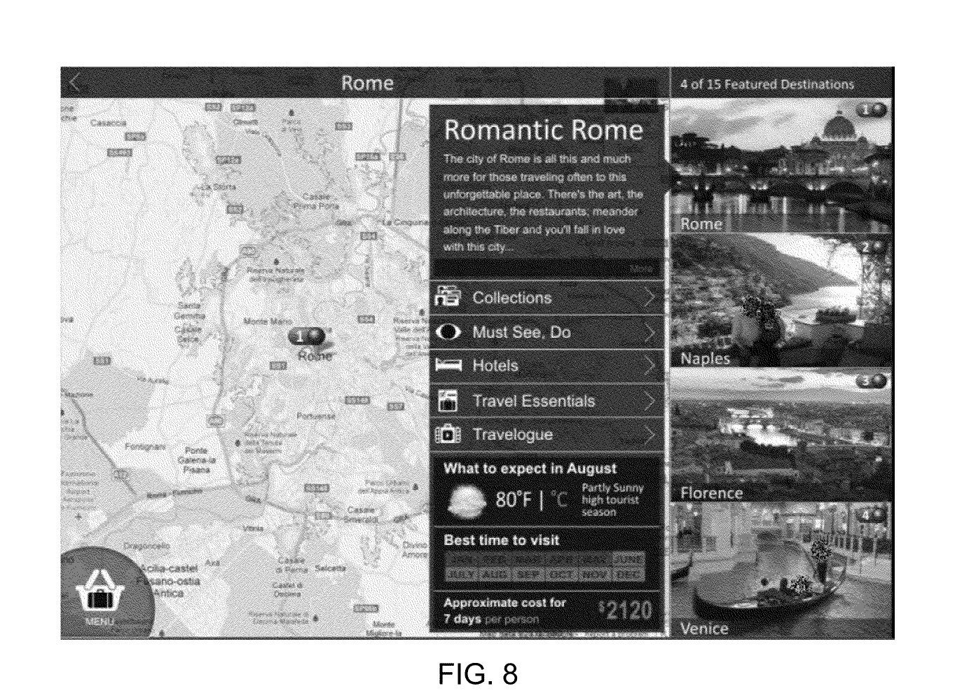

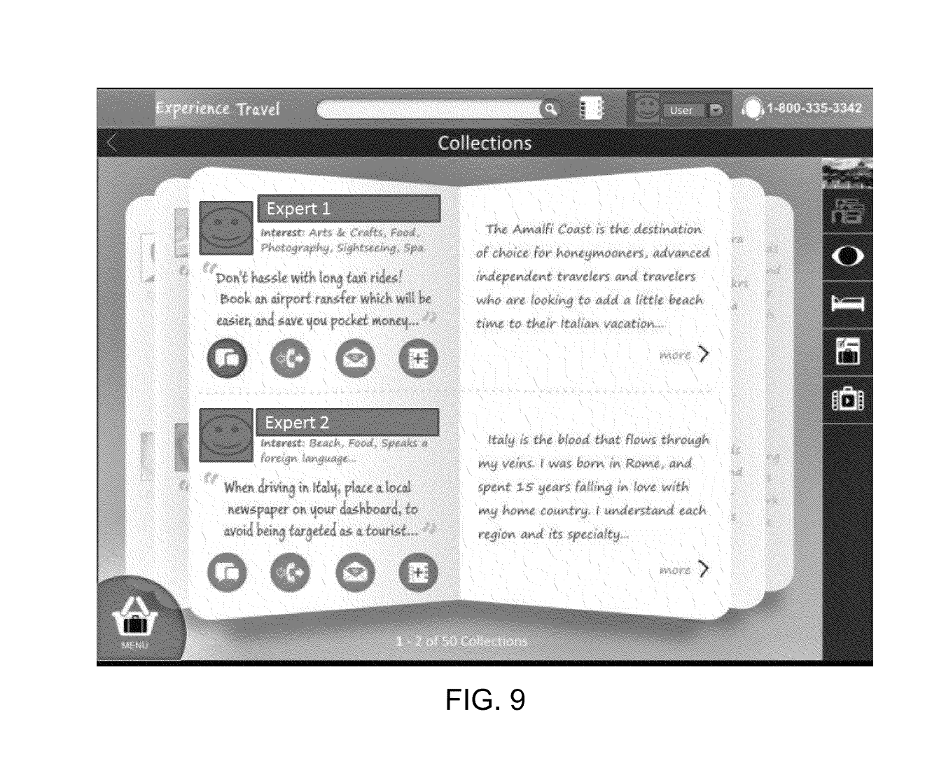

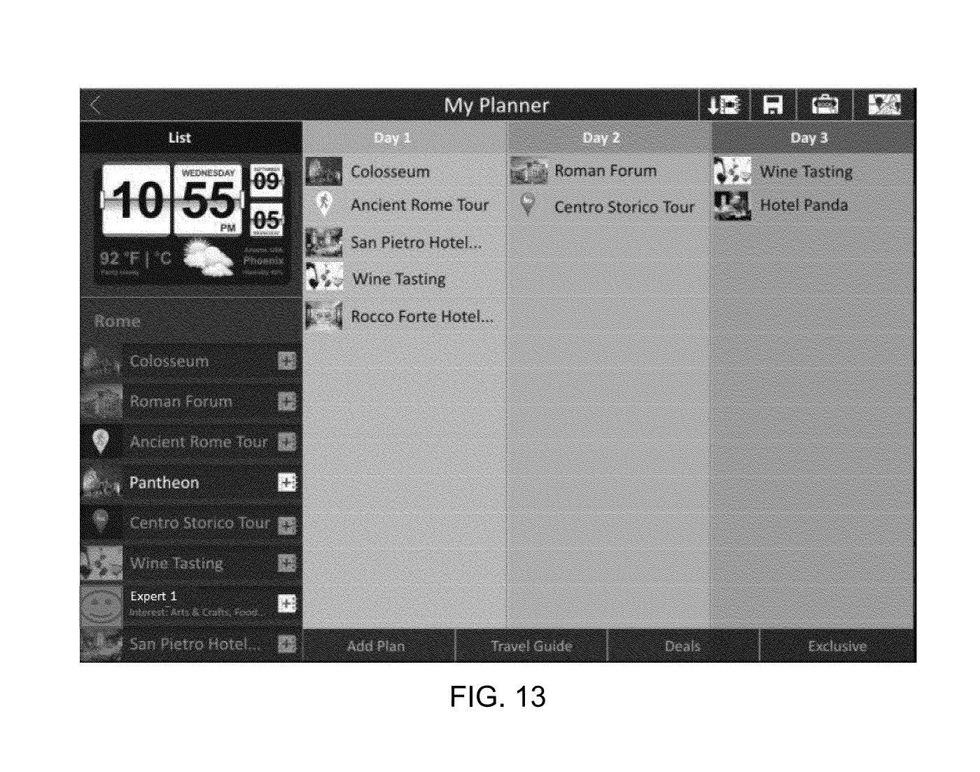

Assume that the user selects Rome as a vacation destination as illustrated in FIG. 8. When the user select Rome, a window is displayed with details of Rome and options such as, collections, ‘must see’, do′, hotels, travel essentials, travelogue, weather details in Rome for vacation dates, best time to visit Rome, approximate cost per person for 7 days and so forth. If the user selects collections button displayed in FIG. 8, information provided by destination experts of Rome is displayed as illustrated in FIG. 9. The buttons at the bottom of each destination expert's name can be used by the user to interact with the destination expert directly via live chat, call and/or email. The plus button is provided to allow the user to add the destination expert to a vacation diary (described as “My Planner” in conjunction with FIG. 13). If the destination expert is online, the color of chat button changes or the chat button is highlighted.

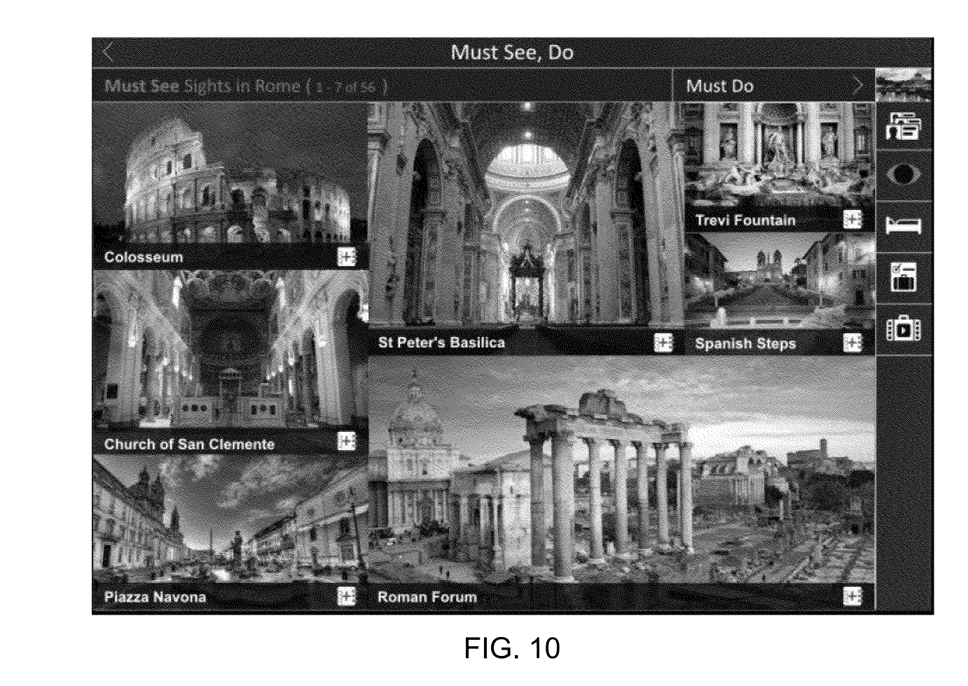

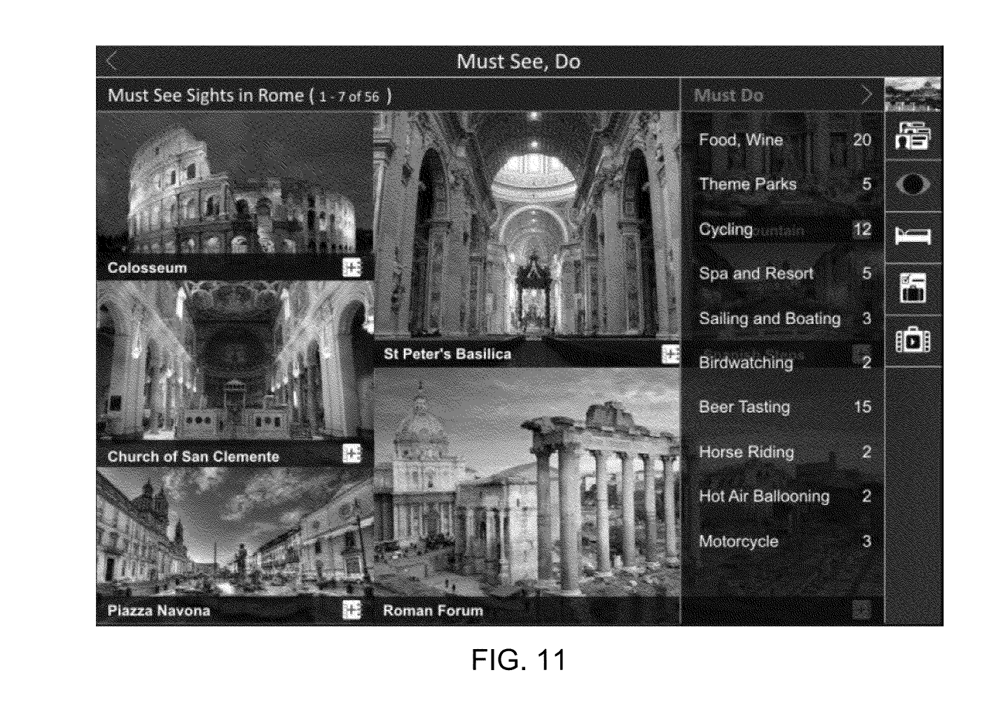

If the user selects ‘must see, do’ illustrated in FIG. 8, the must see, must do options are displayed as illustrated in FIGS. 10 and 11 respectively. For instance, if the user selects ‘must see’, the must see locations in Rome are displayed as illustrated in FIG. 10. If the user selects the ‘Roman Forum’ from the must see locations, a detailed description and a video of the Roman Forum is displayed. If the user selects ‘must do’, the must do activities specific to Rome are displayed, as illustrated in FIG. 11.

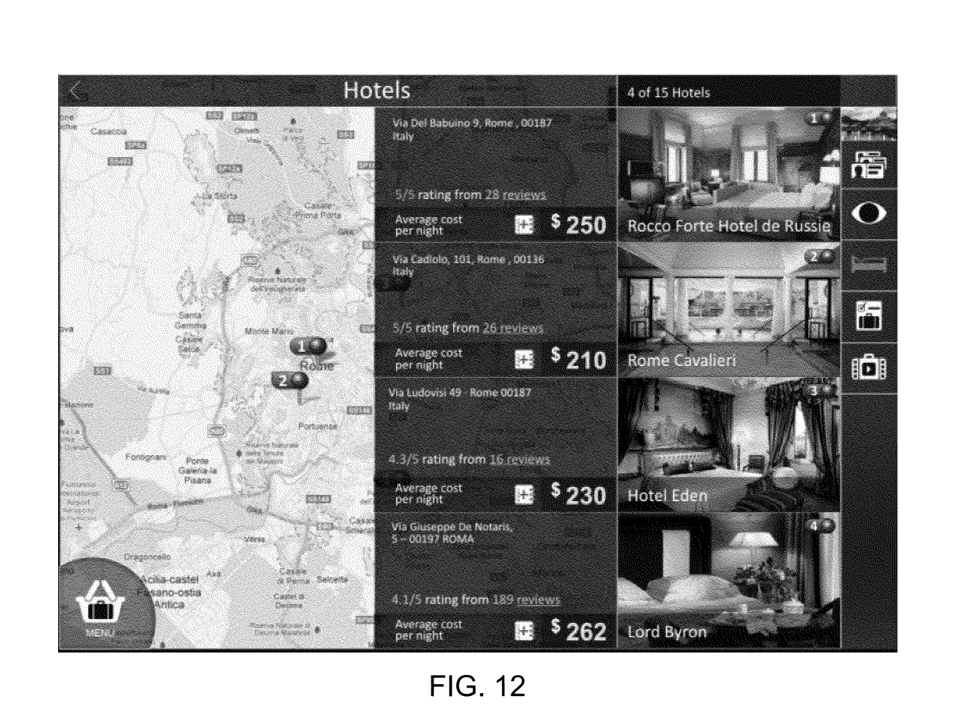

When the user clicks on the hotels option in FIG. 8, name of different hotels in Rome are displayed as illustrated in FIG. 12. Along with the name, information for each hotel is displayed. The information for each hotel includes rating, reviews and average cost per person. The user can add one or more hotels using the plus button to the vacation diary (described as “My Planner’ in conjunction with FIG. 13).

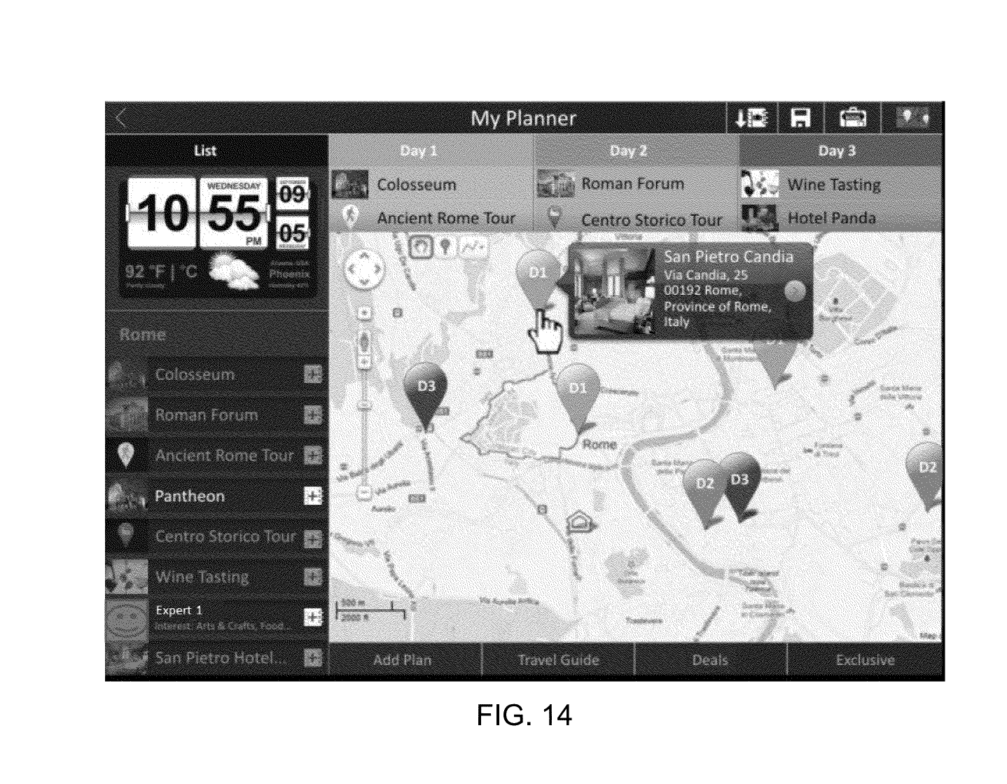

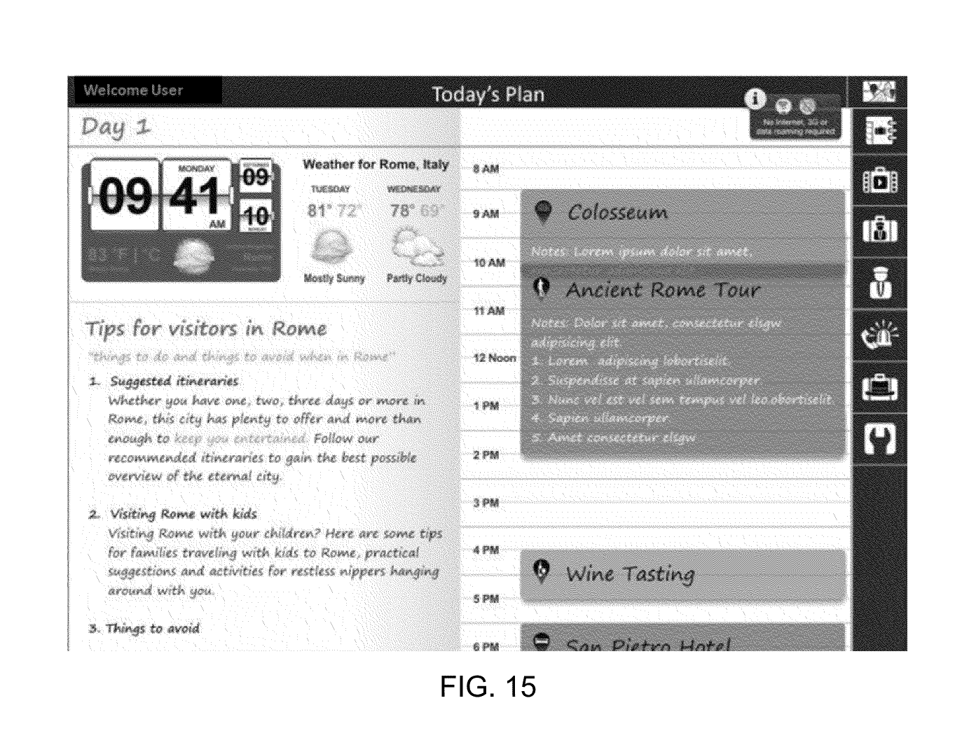

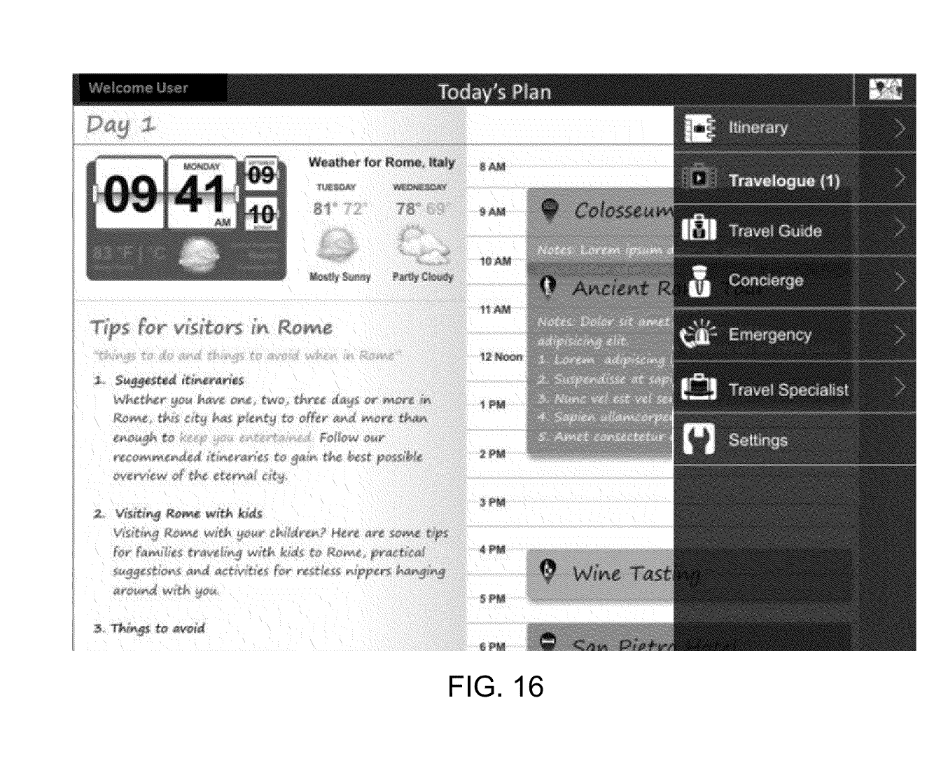

The user can also add one or more of destinations, must-see locations and must-do activities to a planner (the vacation diary) for one or more dates as illustrated in FIG. 13. The user can also view a schedule map for the vacation diary as illustrated in FIG. 14. The planner can be used to display a map of Rome which is pinned with locations to be visited during the vacation as illustrated in FIG. 14. If there is any crisis event in Rome during the vacation dates of the user, then an alert message can be sent to the user either to reschedule the vacation plan or to change the vacation destination. When the user reaches Rome for the vacation, the planner displays the vacation plan for Day 1 as illustrated in FIG. 15. Tips for visitors are also displayed based on vacation plan of the user. The user can also select options such as, itinerary, travelogue, travel guide, concierge, emergency, travel specialist and settings which are displayed along with the planner, as illustrated in FIG. 16.

Thus, the method and system provides four phases of a vacation in one application which includes a planning phase, a booking phase, an in-travel phase and a post travel phase. The disclosed method and system recommends best destinations for vacation planning based on inspirations, desires and preferences provided by a user. During planning and/or travel, the method and system provides intelligent alerts. For example, the user would be provided an alert to reschedule the plan for the day as three selected places to visit in a day is practically not possible. The method and system recommends best booking options for an itinerary selected for the vacation. The method and system also provides in-travel and post-travel support such as, but not limited to, concierge services, crisis management services and an option to create a travelogue.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for facilitating vacation planning and management, the method comprising:
enabling planning of a vacation based on at least one of a user input, a user profile and a travel history associated with the user profile, wherein the user input is received from a user interface;
enabling booking of the vacation via the user interface; and
providing in-travel support, wherein providing the in-travel support comprises providing at least one of a concierge service and a crisis management service during travel, wherein the in-travel support is enabled via the user interface.

2. The method of claim 1 further comprising providing post-travel support, wherein providing the post-travel support comprises enabling submission of a feedback via the user interface.

3. The method of claim 1 further comprising providing a live chat support for facilitating vacation planning and management.

4. The method of claim 1 further comprising enabling sharing of a vacation information on a social network.

5. The method of claim 4, wherein the vacation information is a vacation itinerary.

6. The method of claim 1, further comprising enabling creation of a travelogue via the user interface.

7. The method of claim 1, wherein enabling planning of the vacation comprises generating a recommendation based on at least one of the user input, the user profile and the travel history associated with the user profile.

8. The method of claim 7, wherein the recommendation comprises at least one of a destination, an activity, a mode of transport, an accommodation and an itinerary.

9. The method of claim 1, wherein enabling planning of the vacation comprises facilitating creation of a vacation diary for scheduling at least one of a plurality of destination visits and a plurality of destination activities during the vacation.

10. The method of claim 9 further comprises generating a schedule map based on the vacation diary.

11. The method of claim 9 further comprising generating an alert based on an event in the vacation diary.

12. The method of claim 1, wherein providing the in-travel support further comprises providing promotional content during travel.

13. A system for facilitating vacation planning and management, the system comprising:
a user interface;
a planning and recommendation engine configured to enable planning of a vacation based on at least one of a user input, a user profile and a travel history associated with the user profile;
a booking engine configured to enable booking of the vacation; and
a travel support engine configured to provide an in-travel support, wherein providing in-travel support comprises providing at least one of a concierge service and a crisis management service during travel.

14. The system of claim 13, further comprising a live chat support engine configured to enable a live chat session for facilitating vacation planning and management.

15. The system of claim 13, wherein the planning and recommendation engine is further configured to generate a recommendation based on at least one of the user input, the user profile and the travel history associated with the user profile.

16. The system of claim 13, wherein the planning and recommendation engine is further configured to create a vacation diary for scheduling at least one of a plurality of destination visits and a plurality of destination activities during the vacation.

17. The system of claim 16, wherein the planning and recommendation engine is further configured to generate a schedule map based on the vacation diary.

18. The system of claim 16, wherein the planning and recommendation engine is further configured to generate an alert based on an event in the vacation diary.

19. The system of claim 13, wherein the travel support engine is further configured to provide promotional content during travel.

20. The system of claim 13, wherein the travel support engine is further configured to enable creation of a travelogue.

21. The system of claim 13, wherein the travel support engine is further configured to provide post-travel support, wherein providing the post-travel support comprises enabling submission of feedback.
